(19) United States
(12) Patent Application Publication
(10) Pub. No.: US 2023/0228237 A1
(43) Pub. Date: Jul. 20, 2023

(54) High-Pressure Fuel Pump

(71) Applicant: Robert Bosch GmbH, Stuttgart (DE)

(72) Inventors: Matthias Riedle, Obersulm (DE); Stephan Wehr, Heiligenstadt (DE); Daniel Heinzinger, Sersheim (DE)

(21) Appl. No.: 17/914,595

(22) PCT Filed: Feb. 1, 2021
(86) PCT No.: PCT/EP2021/052247

§ 371 Date: Sep. 26, 2022

(30) Foreign Application Priority Data
Apr. 3, 2020 (DE) 10 2020 204 348.5
Nov. 9, 2020 (DE) 10 2020 214 037.5

(51) Int. Cl. F02M 59/44; F02M 59/48; F02M 59/02

(52) U.S. Cl. CPC F02M 59/442; F02M 59/48; F02M 59/027

(57) ABSTRACT

A high-pressure fuel pump includes a pump housing, a pump piston accommodated in a receiving opening of the pump housing, a high-pressure seal which surrounds the pump piston in a sealing manner and which seals off a high-pressure region from a low-pressure region, and a guide device which comprises at least two guide portions that are axially spaced apart from one another and guide the pump piston with a sliding fit. The at least two guide portions are arranged in the receiving opening of the pump housing. A first guide portion is arranged, as seen in an axial direction, on a side of the high-pressure seal facing toward the delivery space. And a second guide portion is arranged, as seen in the axial direction, on a side of the high-pressure seal facing away from the delivery space.

### PRIOR ART

The invention relates to a high-pressure fuel pump as per the preamble of claim 1.

High-pressure fuel pumps for fuel systems of internal combustion engines are known commercially. Said high-pressure pumps compress the fuel to a high pressure and conduct said fuel into a fuel collecting line (“rail”), from where the fuel is injected directly into combustion chambers of the internal combustion engine. A pump piston is guided in the pump housing, and the pump piston is forced in the direction of a drive by a piston spring. It is known from DE 10 2013 226 088 A1 for the pump piston to be mounted and guided relative to the pump housing at two axially mutually spaced-apart points, inter alia by means of a ring-shaped guide element, for example. It is furthermore known from DE 10 2013 226 088 A1 for a high-pressure seal to be arranged between the pump piston and the housing, which high-pressure seal seals off a high-pressure region with respect to a low-pressure region.

### DISCLOSURE OF THE INVENTION

The problem on which the present invention is based is achieved by means of a high-pressure fuel pump having the features of claim 1. Advantageous refinements are specified in the subclaims.

By means of the invention, a guide ring that has hitherto been arranged on a separate seal carrier can be omitted.

The axial spacing between the two guide portions is thus reduced, whereby the pump piston can be introduced more advantageously during the installation process. Also, the risk of damage to a low-pressure seal during the installation of the pump piston is reduced because, as it is installed, the pump piston is brought to the seal carrier and thus to the low-pressure seal with less of an axis offset and less obliquely, and a situation in which the pump piston arrives off-center is hereby avoided. A coaxial offset of the pump piston is also reduced, such that the pump piston can tilt less both during the installation process and during operation. In this way, the transverse forces that act on the pump piston are lower, which ultimately leads to reduced wear on the pump piston. Furthermore, the transverse forces are introduced into the pump housing not via the seal carrier of the low-pressure seal but directly, whereby strength is improved. The second guide portion also serves as a clamping ring for securing the high-pressure seal in its axial position.

This is achieved specifically by means of a high-pressure fuel pump having a pump housing and a pump piston. The pump housing may for example be polygonal or rotationally symmetrical, and is normally produced from metal. The pump piston is commonly a stepped piston which, by way of a portion of relatively large diameter, delimits a delivery chamber, whereas a portion of relatively small diameter is forced toward a drive by a piston spring. The drive may for example comprise an eccentric portion or a cam portion.

The high-pressure fuel pump is commonly a so-called “plug-in pump” which is plugged into an opening in a cylinder head of an engine block and which is driven by a camshaft of the internal combustion engine. Here, the pump piston is received in a receiving opening of the pump housing. Said receiving opening is commonly stepped and in the form of a blind bore, and is commonly produced by way of a cutting process, for example drilling. A longitudinal axis of the receiving opening may be coaxial with respect to a longitudinal axis of the pump housing.

The high-pressure fuel pump also includes a high-pressure seal which sealingly surrounds and bears against the pump piston and which seals off a high-pressure region with respect to a low-pressure region. Said high-pressure seal may likewise be ring-shaped and have one or more sealing lips. The high-pressure fuel pump furthermore comprises a guide device for the pump piston, which guide device has at least two guide portions which are spaced apart from one another axially—as viewed in a longitudinal direction of the pump piston—and which guide the pump piston with a sliding fit.

Unlike before, said two guide portions are arranged within the receiving opening of the pump housing, specifically to both sides of the high-pressure seal. A first guide portion is thus, as viewed in an axial direction, arranged on a side of the high-pressure seal pointing toward a delivery chamber, and a second guide portion is, as viewed in the axial direction, arranged on a side of the high-pressure seal averted from the delivery chamber. The axial spacing of the two guide portions results in an axial overall length of the guide device which approximately corresponds to the axial guide length of a piston bushing known from the prior art and which reliably prevents undesired tilting of the piston.

In one refinement of the invention, provision is made whereby at least one of the guide portions and the high-pressure seal are provided on a preassembled arrangement (“cartridge”) which is arranged in the receiving opening of the pump housing, preferably pressed into the receiving opening. Such a preassembled arrangement has the advantage that the risk of a component being forgotten about during the assembly of the high-pressure fuel pump is reduced, because the components are provided in ready-preassembled form for the final assembly process. Also, the risk of a component being installed in an incorrect position is reduced, and additional monitoring for quality control with regard to correctly positioned installation during the final assembly process can be omitted. Such a preassembled arrangement can have the same external dimensions as a piston bushing in high-pressure fuel pumps from the prior art, such that the pump housing thereof can continue to be used, that is to say existing production plants and processes can continue to be used. Here, the axial length of the guide portions can be adapted correspondingly.

In particular if not only one of the guide portions but both guide portions and the high-pressure seal that is arranged between said guide portions as viewed in an axial direction are provided as a preassembled assembly, these can be installed at a single assembly station during the final assembly of the high-pressure fuel pump. It is also possible for the preassembled arrangement to be procured as a whole from a subsupplier, which can lower costs. Also, said preassembled assembly can be measured and tested in terms of its functionality in advance, that is to say before the final assembly process. If pairing with the pump piston is required at a later point in time, the preassembled arrangement can be classified in accordance with the inner diameter.

In one refinement in this regard, provision is made whereby the preassembled arrangement comprises a sleeve, in or on which at least one of the guide portions and the high-pressure seal are arranged. This can be implemented particularly easily and inexpensively, and such a sleeve can be very easily pressed into the receiving opening.

In one refinement in this regard, provision is made whereby at least one of the guide portions is formed integrally with the sleeve, and the high-pressure seal is received in the sleeve. The sleeve thus has, in certain portions, the function of a bushing that receives the corresponding counterpart, in the present case the pump piston, in an accurately fitting manner. Owing to the integral form, the number of parts to be handled is yet further reduced.

In one refinement in this regard, provision is made whereby at least one of the guide portions is pressed into the sleeve. This is technically easy to implement and makes it possible for the high-pressure seal to be retained securely between the two guide portions. This is the case in particular if the other guide portion is formed integrally with the sleeve.

In one refinement, it is proposed that the two guide portions are of identical configuration, as so-called “identical parts”. In this way, the assembly process is considerably simplified, and this also has considerable logistical advantages.

The use of identical parts yields the crucial advantage that the functions of “piston guidance” and “clamping of the high-pressure seal” can be implemented directly in the housing. A hitherto required guide ring in the seal carrier of the low-pressure seal can thus be omitted.

In one refinement, it is proposed that at least one of the guide portions is, as viewed in an axial direction, of symmetrical configuration relative to a central plane that is arranged orthogonally with respect to the axial direction. In the simplest case, such a guide portion may be designed as a ring which does not vary in a longitudinal direction or as a pipe which does not vary in a longitudinal direction. In this way, the assembly process is considerably simplified yet further, because there is no need to ensure a correct orientation or alignment of the guide portion during the installation process.

In one refinement, provision is made whereby the high-pressure fuel pump, in particular the preassembled arrangement, has a first fluidic connection which fluidically connects a first region, which is adjacent to a first end surface of the first guide portion, to a second region, which is adjacent to a second end surface of the first guide portion. By means of the fluidic connection, it is ensured that a high fluid pressure prevailing in the high-pressure region prevails, substantially without throttling, across the first guide portion as far as the high-pressure seal, specifically even if a guide gap between the pump piston and the first guide portion is only relatively small (“narrow guide clearance”). It is however ensured by way of such a small guide gap that tilting of a longitudinal axis of the pump piston relative to an ideal guide axis or central axis of the high-pressure seal is relatively minor, whereby, firstly, damage to the high-pressure seal and, secondly, non-uniform sealing by the high-pressure sealing ring against the pump piston and/or against a portion on the housing are prevented.

In one refinement, provision is made whereby the high-pressure fuel pump, in particular the preassembled arrangement, has a second fluidic connection which fluidically connects a first region, which is adjacent to a first end surface of the second guide portion, to a second region, which is adjacent to a second end surface of the second guide portion. This is based on the consideration that there are operating situations in which fluid passes through the high-pressure seal. This is the case in particular if a pressure level in the high-pressure region is relatively low. In such a situation, the fluid that has flowed across the high-pressure seal can flow off via the second guide portion into a low-pressure region.

In one refinement, provision is made whereby the first fluidic connection and/or the second fluidic connection comprises at least one fluid channel, which extends altogether in an axial direction through the respective guide portion, and/or comprises a groove, which extends altogether in an axial direction, in a radially inner lateral surface of the respective guide portion, and/or, if the guide portions are arranged in a sleeve, comprises a flattening or a groove on a radially outer lateral surface of the sleeve. These types of fluidic connection can be implemented easily and inexpensively.

In one refinement, provision is made whereby the fluid channel and/or the groove is arranged obliquely relative to a longitudinal axis of the first and/or second guide portion. In this way, the guidance functions of the guide portions are influenced as little as possible by the fluidic connection.

In one refinement, provision is made whereby the two guide portions and the high-pressure seal are pressed directly into the receiving opening of the pump housing. This yields numerous advantages of the invention without the need for further modifications to the design of the high-pressure fuel pump.

The invention will be discussed below with reference to the appended drawing, in which:

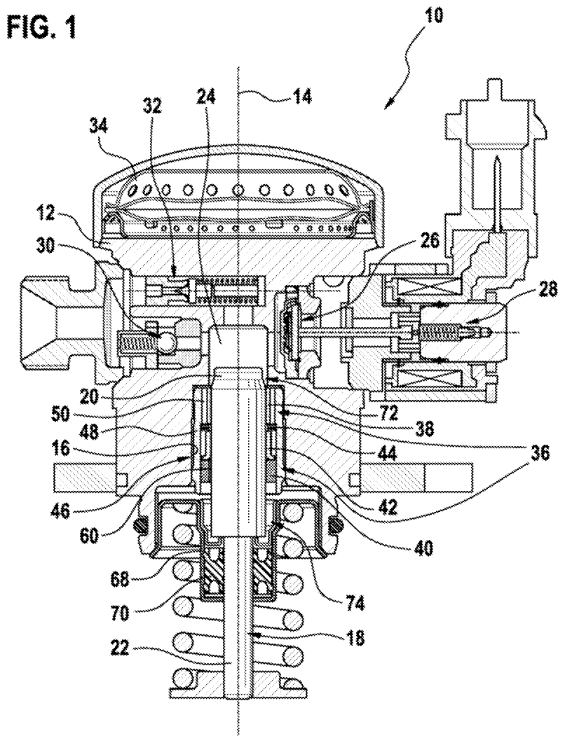

FIG. 1 shows a longitudinal section through a high-pressure fuel pump having a first embodiment of a preassembled arrangement with a sleeve, with two guide portions and with a high-pressure seal arranged therebetween;

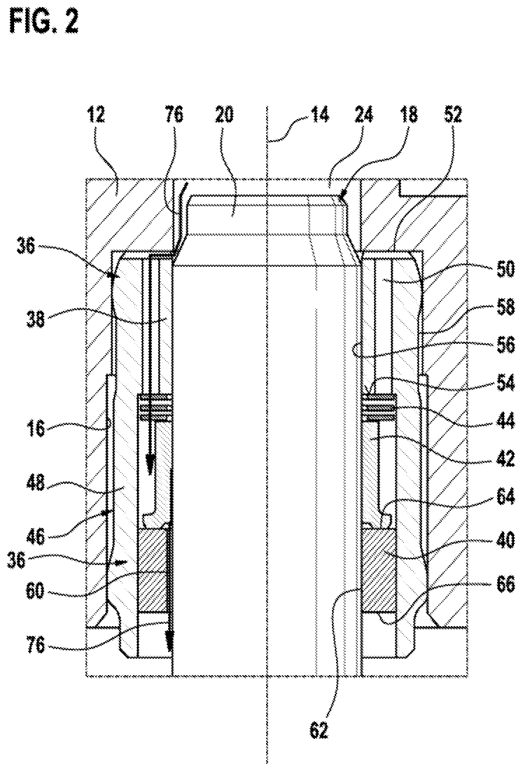

FIG. 2 shows a longitudinal section through an enlarged region the high-pressure fuel pump from FIG. 1, showing the preassembled arrangement;

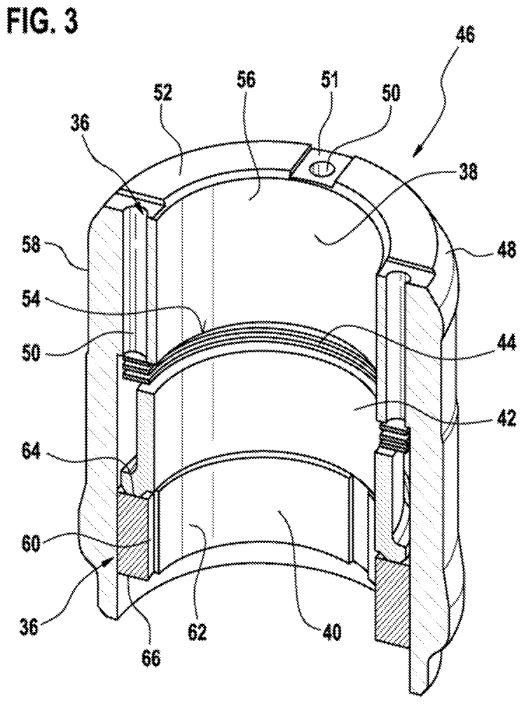

FIG. 3 shows a perspective sectional illustration of the preassembled arrangement from FIG. 1;

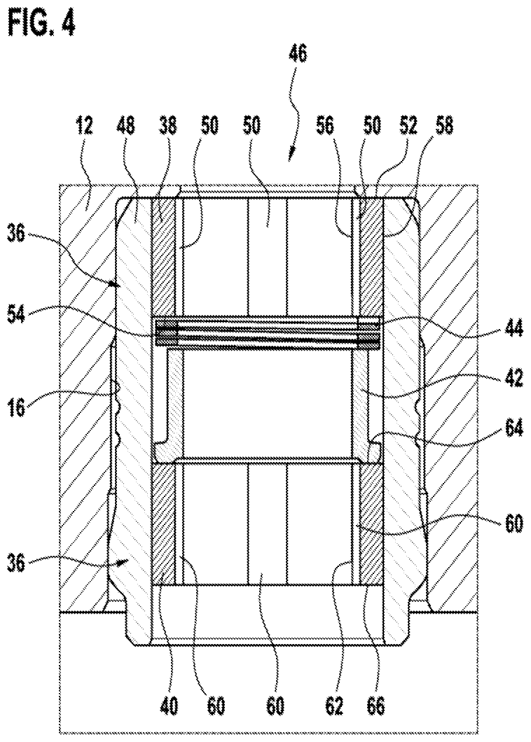

FIG. 4 shows an illustration similar to FIG. 2 of a second embodiment of a preassembled arrangement; and

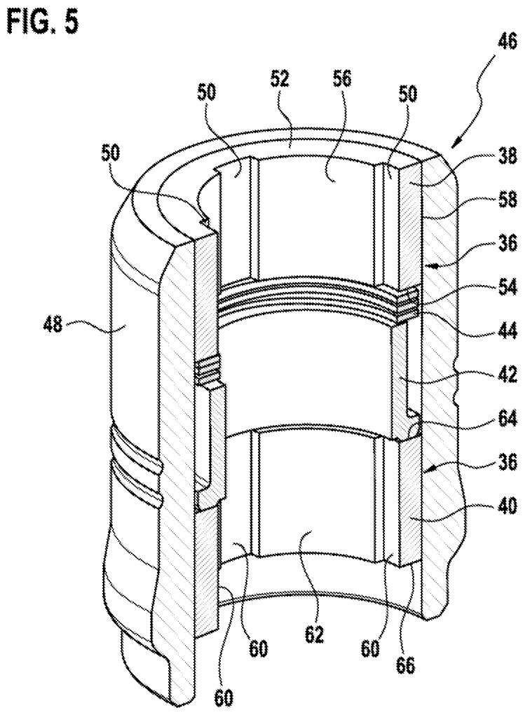

FIG. 5 shows an illustration similar to FIG. 3 of the second embodiment of FIG. 4.

In the figures, elements and regions of equivalent function are denoted by the same reference designations in different embodiments.

In the figures, a high-pressure fuel pump for a fuel system of an internal combustion engine is denoted as a whole by the reference designation 10. Said high-pressure fuel pump comprises a pump housing 12, which in the present case is, by way of example, of approximately cylindrical overall shape with a longitudinal axis 14. In the present case, by way of example, a stepped receiving opening 16, which is formed in the manner of a blind bore and which is produced for example by way of a drilled hole, is provided in the pump housing 12 coaxially with respect to the longitudinal axis 14, in which receiving opening a pump piston 18 is received in a manner that will be presented in more detail.

The pump piston 18 is configured as an elongate cylindrical part with a first portion 20 and a second portion 22 as viewed in an axial direction. The first portion 20 has a greater diameter than the second portion 22. The first portion 20 faces toward a delivery chamber 24, whereas the second portion 22 faces toward a drive (not illustrated).

The high-pressure fuel pump 10 also includes an inlet valve 26, which is configured as a check valve but which can be forcibly held in an open position by an electromagnetic actuating device 28. The high-pressure fuel pump 10 furthermore includes an outlet valve 30 configured as a check valve, and a pressure-limiting valve 32. Furthermore, in FIG. 1, a membrane-type damper 34 for damping low-pressure pulsations is provided in the region of an upper end surface (without reference designation) of the pump housing 12.

The high-pressure fuel pump 10 is part of a fuel system (not illustrated in any more detail) of an internal combustion engine. The fuel, for example gasoline or diesel, passes to the inlet valve 26 from a predelivery pump, which is normally electrically driven. At its lower end in FIG. 1, the pump piston 18 is set in reciprocating motion by a drive, for example a camshaft of the internal combustion engine, whereby fuel is drawn into the delivery chamber 24 via the inlet valve 26, is compressed there to a high pressure, and is ultimately discharged via the outlet valve 30 to a fuel collecting line (“rail”). From there, the fuel passes via injectors into associated combustion chambers.

The pump piston 18 is guided relative to the pump housing 12 in the receiving opening 16 by a guide device 36, which has two ring-shaped guide portions 38 and 40 which are spaced apart from one another axially (that is to say as viewed in the direction of the longitudinal axis 14 of the pump housing 12 and of the pump piston 18). A high-pressure seal 42, which is likewise altogether ring-shaped, is provided between the two guide portions 38 and 40. The high-pressure seal 42 may be produced for example from a PTFE material.

By means of the two portions 38 and 40, the pump piston 18 is guided at two points which are spaced apart from one another axially, specifically firstly, slightly below the delivery chamber 24, by the first ring-shaped guide portion 38. The latter is arranged, as viewed in the direction of the longitudinal axis 14, on a side of the high-pressure seal 42 pointing toward the delivery chamber 24. Secondly, the pump piston 18 is guided, slightly above the lower end of the receiving opening 16 in FIG. 1, by the second ring-shaped guide portion 40. Said guide portion is, as viewed in the direction of the longitudinal axis 14, arranged on the side of the high-pressure seal 42 averted from the delivery chamber 24.

A ring-shaped spring 44, also referred to as “wave spring”, is braced between the high-pressure seal 42 and the first guide portion 38. This may for example be a disk spring or a helical spring. By means of the spring 44, the high-pressure seal 42 is forced against the second guide portion 40, which thus forms a holding portion for the high-pressure seal 42.

The guide device 36 with the two guide portions 38 and 40, and the high-pressure seal 42 with the spring 44, are part of a preassembled arrangement 46. This comprises, as an element which connects and encases the above-stated elements and portions, a sleeve 48 that is pressed into the receiving opening 16. As can in particular also be seen from FIGS. 2 and 3, the first guide portion 38 is in the present case, by way of example, formed integrally with the sleeve 48. During the pre-assembly process, the spring 44 and the high-pressure seal 42 are firstly introduced into the sleeve 48 from the lower end thereof, which is averted from the first guide portion 38, and then the second guide portion 40, which is initially a separate ring-shaped part, is pressed into the sleeve 48. The sleeve 48 with the integral first guide portion 38 and the second guide portion 40 may be produced from a metal, for example from high-grade steel.

It can also be seen from FIGS. 2 and 3 that the preassembled arrangement 46 has a first fluidic connection 50 in the region of the first guide portion 38. In the present case, by way of example, said first fluidic connection comprises four fluid channels which are arranged so as to be distributed uniformly in a circumferential direction of the first guide portion 38 and which extend in an axial direction from depressions 51 in a first ring-shaped end surface 52 of the first guide portion 38 to a second ring-shaped end surface 54 of the first guide portion 38. The fluidic connections or fluid channels 50 may be produced for example by way of drilled through holes. In the installed position illustrated in FIGS. 1 and 2, the sleeve 48 bears by way of the first end surface 52 against a shoulder (without reference designation) of the stepped receiving opening 16. By means of the first fluidic connection 50, a first region, which is adjacent to the first end surface 52, is fluidically connected to a second region, which is adjacent to the second end surface 54.

In an embodiment which is not shown, the fluidic connection may alternatively or additionally comprise at least one groove, which extends altogether in an axial direction (longitudinal axis 14), in a radially inner lateral surface 56 of the first guide portion 38. Said groove may run parallel to the longitudinal axis 14 or may run obliquely with respect to the longitudinal axis 14 and thus helically. In a further embodiment which is not shown, the fluidic connection may comprise at least one flattening or one groove on a radially outer lateral surface 58 of the sleeve 48. In order, in this case, to produce the fluidic connection to the region adjacent to the second end surface 54 of the first guide portion 38, it would be necessary for a passage opening proceeding from the flattening or from the groove and extending altogether in a radial direction to be provided through the wall of the sleeve 48 approximately at an axial level of the high-pressure seal 42.

The preassembled arrangement 46 furthermore has a second fluidic connection 60, which in the present case, by way of example, is formed by four grooves which are arranged so as to be distributed uniformly in a circumferential direction of the second guide portion 40 and which are formed in a radially inner lateral surface 62 of the second guide portion 40. In the present case, by way of example, the grooves 60 extend parallel to the longitudinal axis 14. In an embodiment which is not illustrated, said grooves could also run obliquely with respect to the longitudinal axis 14 and thus helically. By means of the second fluidic connection 60, a first region, which is adjacent to a first end surface 64 of the second guide portion 40, is fluidically connected to a second region, which is adjacent to a second end surface 66.

The high-pressure fuel pump 10 furthermore includes a seal carrier 68, which carries a low-pressure seal 70. Said low-pressure seal is likewise ring-shaped and bears sealingly against the second portion 22 of the pump piston 18. Whereas the region which, in FIGS. 1 and 2, is arranged above the high-pressure seal 42 between the pump housing 12 and the pump piston 18 and which is fluidically connected to the delivery chamber 24 forms a high-pressure region 72, in which at least approximately the high fluid pressure prevailing in the delivery chamber 24 during a delivery stroke at least intermittently prevails, the region which, in FIGS. 1 and 2, is arranged below the high-pressure seal 42 between the pump housing 12, the pump piston 18, the seal carrier 68 and the low-pressure region 70 forms a low-pressure region 74.

For an optimum sealing action of the high-pressure seal 42, it is necessary for the high fluid pressure (gasoline or diesel, for example, may be used as fluid) prevailing in the high-pressure region 72 to prevail, with the least possible throttling, as far as the high-pressure seal 42.

This is associated with the fact that the high-pressure seal 42 typically has one or more sealing lips, at whose region averted from the high-pressure region 72 the relatively low fluid pressure of the low-pressure region 74 prevails. Therefore, in order to achieve an optimum sealing action, the sealing lips are forced by the high fluid pressure prevailing in the high-pressure region 72 against the movable pump piston 18 and against the second guide portion 40.

In the case of the high-pressure fuel pump 10 described here, it is ensured by means of the first fluidic connection 50 through the first guide portion 38 that the high fluid pressure prevails, substantially without throttling, across the first guide portion 38 as far as the high-pressure seal 42, specifically even if a guide gap between the pump piston 18 and the first guide portion 38 is only relatively small. Here, the depressions 51 ensure that the pressure prevailing in the high-pressure region 72 can be transmitted through the fluid channels 50 even though the sleeve 48 bears with the first end surface 52 against the shoulder (without reference designation) of the receiving opening 16.

Furthermore, there may be operating situations in which fluid passes through the high-pressure seal 42. This is the case in particular if a pressure level in the high-pressure region 72 is relatively low. In such a situation, the fluid that has flowed across the high-pressure seal 42 can flow off through the second fluidic connection 60 into the low-pressure region 74. The fluid flows through the fluidic connections 50 and 60 are symbolized in FIG. 2 by arrows 76.

An alternative embodiment, which can also be referred to as a “cartridge solution”, of a preassembled arrangement 46 will now be discussed with reference to FIGS. 4 and 5. By contrast to the embodiment of FIGS. 1-3, it is the case in the embodiment of FIGS. 4-5 that the first guide portion 38 is also designed as a part which is (initially) separate from the sleeve 48, specifically as a guide ring, which is pressed into the sleeve 48. It can furthermore be seen that the two guide portions 38 and 40 are of absolutely identical configuration with respect to one another, that is to say constitute so-called “identical parts”. Here, the two guide portions 38 and 40 are of substantially identical design to the guide portion 40 of the embodiment of FIGS. 1-3, that is to say are each designed as a cylindrical ring which, as viewed in an axial direction (longitudinal axis 14), is of symmetrical configuration relative to a central plane that is orthogonal with respect to the axis 14, that is to say which does not vary in its longitudinal direction.

The first fluidic connection 50 is, like the second fluidic connection 60, designed in the form of a multiplicity of grooves, which are arranged so as to be distributed uniformly in a circumferential direction and which run in a longitudinal direction of the guide portions 38 and 40, on the radially inner lateral surface 56 or 62 respectively of the two guide portions 38 and 40. Whereas the grooves 50 in the first guide portion 38 serve for the “pressure activation” of the high-pressure seal 42, the grooves 60 in the second guide portion 40 serve for pressure equalization and for lubrication of the low-pressure seal 70 that is not shown in FIGS. 4 and 5.

In an embodiment which is not illustrated, the two guide portions and the high-pressure seal and the spring between the high-pressure seal and the first guide portion are pressed directly into the receiving opening in the pump housing. In this case, a preassembled arrangement by way of a sleeve is omitted.

1. A high-pressure fuel pump, comprising:
a pump housing defining a receiving opening;
a pump piston which is received in the receiving opening;
a high-pressure seal which sealingly surrounds the pump piston and which is configured to seal off a high-pressure region with respect to a low-pressure region; and
a guide device which includes at least two guide portions which are spaced apart from one another axially and which are configured to guide the pump piston with a sliding fit,
wherein the at least two guide portions are arranged in the receiving opening of the pump housing,
wherein a first guide portion of the at least two guide portions is, as viewed in an axial direction, arranged on a side of the high-pressure seal pointing toward a delivery chamber, and
wherein a second guide portion of the at least two guide portions is, as viewed in the axial direction, arranged on a side of the high-pressure seal averted from the delivery chamber.

2. The high-pressure fuel pump as claimed in claim 1, wherein at least one of the at least two guide portions, and the high-pressure seal are provided on a preassembled arrangement which is arranged in the receiving opening of the pump housing.

3. The high-pressure fuel pump as claimed in claim 2, wherein the preassembled arrangement comprises a sleeve, in or on which the at least one of the at least two guide portions, and the high-pressure seal are arranged.

4. The high-pressure fuel pump as claimed in claim 3, wherein:
the at least one of the at least two guide portions is formed integrally with the sleeve, and
the high-pressure seal is received in the sleeve.

5. The high-pressure fuel pump as claimed in claim 3, wherein the at least one of the at least two guide portions is pressed into the sleeve.

6. The high-pressure fuel pump as claimed in claim 1, wherein the first guide portion and the second guide portion are of identical configuration.

7. The high-pressure fuel pump as claimed in claim 1, wherein at least one of the at least two guide portions is, as viewed in an axial direction, of symmetrical configuration relative to a central plane.

8. The high-pressure fuel pump as claimed in claim 1, wherein said high-pressure fuel pump has a first fluidic connection which fluidically connects a first region which is adjacent to a first end surface of the first guide portion, to a second region which is adjacent to a second end surface of the first guide portion.

9. The high-pressure fuel pump as claimed in claim 8, wherein said high-pressure fuel pump has a second fluidic connection which fluidically connects a third region which is adjacent to a first end surface of the second guide portion, to a fourth region which is adjacent to a second end surface of the second guide portion.

10. The high-pressure fuel pump as claimed in claim 8, wherein the first fluidic connection and/or the second fluidic connection comprises at least one fluid channel, which extends altogether in an axial direction through the respective guide portion, and/or comprises a groove, which extends altogether in an axial direction, in a radially inner lateral surface of the respective guide portion, and/or, if the guide portions are arranged in a sleeve, comprises a flattening or a groove on a radially outer lateral surface of the sleeve.

11. The high-pressure fuel pump as claimed in claim 10, wherein the fluid channel and/or the groove is arranged obliquely relative to a longitudinal axis of the first and/or second guide portion.

12. The high-pressure fuel pump as claimed in claim 1, wherein the at least two guide portions and the high-pressure seal are pressed directly into the receiving opening of the pump housing.

13. The high-pressure fuel pump as claimed in claim 1, wherein at least one of the at least two guide portions and the high-pressure seal are provided on a preassembled arrangement which is press fit into in the receiving opening of the pump housing.
